(19) United States
(12) Patent Application Publication
(10) Pub. No.: US 2014/0078274 A1
(43) Pub. Date: Mar. 20, 2014

(54) AUTOSTEREOSCOPIC DISPLAY DEVICE

(71) Applicant: KONINKLIJKE PHILIPS ELECTRONICS N.V., Eindhoven (NL)

(72) Inventors: Bart Kroon, Eindhoven (NL); Mark Thomas Johnson, Arendonk (BE); Martinus Hermanus Wilhelmus Maria Van Delden, Venlo (NL); Philip Steven Newton, Eindhoven (NL)

(73) Assignee: KONINKLIJKE PHILIPS N.V., EINDHOVEN (NL)

(21) Appl. No.: 14/119,558

(22) PCT Filed: May 15, 2012
(86) PCT No.: PCT/IB2012/052421

§ 371 Date: Nov. 22, 2013

(30) Foreign Application Priority Data
May 30, 2011 (EP) 11168099.7

(51) Int. Cl. H04N 13/04

(52) U.S. Cl. CPC H04N 13/0404
USPC 348/59

(57) ABSTRACT

A lenticular lens based autostereoscopic display arrangement uses a display arrangement such as an emissive display arrangement or a reflective display arrangement. The interface between adjacent lenticular lenses (49) is interrupted by a light shielding arrangement (50), which extends at least from the lens surface at the interface into the lens structure, thereby providing a shield extending beneath the lens surface. This reduces lateral progression of light in the lenticular lens arrangement and thereby reduces cross talk caused by waveguiding in the lens material.

### FIELD OF THE INVENTION

This invention relates to an autostereoscopic display device of the type that comprises a display panel having an array of display pixels for producing a display and an imaging arrangement for directing different views to different spatial positions.

### BACKGROUND OF THE INVENTION

A first example of an imaging arrangement for use in this type of display is a barrier, for example with slits that are sized and positioned in relation to the underlying pixels of the display. In a two-view design, the viewer is able to perceive a 3D image if his/her head is at a fixed position. The barrier is positioned in front of the display panel and is designed so that light from the odd and even pixel columns is directed towards the left and right eye of the viewer, respectively.

A drawback of this type of two-view display design is that the viewer has to be at a fixed position, and can only move approximately 3 cm to the left or right. In a more preferred embodiment there are not two sub-pixel columns beneath each slit, but several. In this way, the viewer is allowed to move to the left and right and perceive a stereo image in his/her eyes all the time.

The barrier arrangement is simple to produce but is not light efficient. A preferred alternative is therefore to use a lens arrangement as the imaging arrangement. For example, an array of elongate lenticular elements can be provided extending parallel to one another and overlying the display pixel array, and the display pixels are observed through these lenticular elements.

The lenticular elements are provided as a sheet of elements, each of which comprises an elongate semi-cylindrical lens element. The lenticular elements extend in the column direction of the display panel, with each lenticular element overlying a respective group of two or more adjacent columns of display pixels.

In an arrangement in which, for example, each lenticule is associated with two columns of display pixels, the display pixels in each column provide a vertical slice of a respective two dimensional sub-image. The lenticular sheet directs these two slices and corresponding slices from the display pixel columns associated with the other lenticules, to the left and right eyes of a user positioned in front of the sheet, so that the user observes a single stereoscopic image. The sheet of lenticular elements thus provides a light output directing function.

In other arrangements, each lenticule is associated with a group of four or more adjacent display pixels in the row direction. Corresponding columns of display pixels in each group are arranged appropriately to provide a vertical slice from a respective two dimensional sub-image. As a user's head is moved from left to right, a series of successive, different, stereoscopic views are perceived creating, for example, a look-around impression.

Known autostereoscopic displays use liquid crystal displays to generate the image.

There is increasing interest in the use of emissve displays, such as electroluminescent displays, for example organic light emitting diode (OLED) displays, as these do not need polarizers, and potentially they should be able to offer increased efficiency since the pixels are turned off when not used to display an image, compared to LCD panels which use a continuously illuminated backlight.

There is also increasing interest in the use of reflective displays, such as electrophoretic displays and electrowetting displays.

This invention is based on the use, within an autostereoscopic display system, of a display arrangement that is emissive or reflective.

Emissve displays such as OLED displays and reflective displays such as electrophoretic displays differ significantly from LCD displays in how the light is emitted from the pixel. OLED pixels are emitters that emit light over a wide range of directions, and electrophoretic pixels are reflectors that reflect light over a wide range of directions. In the context of the present invention, such emitters and reflectors are also called diffuse emitters and diffuse reflectors, respectively. For a conventional (2D) display, OLED displays have a clear advantage over LCD displays that require a backlight and which, without taking special measures, emit light only in a narrow beam. However, the diffuse emission of the OLED material also poses a challenge as a lot of light is recycled inside the organic layers and is not emitted giving rise to a low efficiency. To improve, this various solutions have been sought to improve the out-coupling of the light out of the OLED.

However this improvement for 2D displays is in fact a problem for 3D autostereoscopic OLED displays. The solutions for increasing the light output cannot be used in autostereoscopic lenticular displays, as the light intended to be emitted from one lenticular lens may be reflected in the glass to a neighbouring lens. This reduces contrast and increases crosstalk.

Reflective displays such as electrophoretic and electrowetting displays may give rise to similar drawbacks as discussed above for emissive displays in the form of OLED displays.

Thus, there is a conflict between the desire for using emissive and reflective displays and the desire for low crosstalk within a 3D autostereoscopic display.

### SUMMARY OF THE INVENTION

According to the invention, there is provided an autostereoscopic display device comprising:

a display arrangement comprising an array of spaced pixels;

an autostereoscopic lens arrangement comprising an array of parallel lenticular lenses over the display arrangement, wherein a plurality of pixels is provided beneath each lenticular lens,

wherein the interface between adjacent lenticular lenses is provided with a light shielding arrangement, which extends at least from the lens surface at the interface between the adjacent lenticular lenses into the lens structure, thereby providing a shield extending beneath the lens surface.

In an embodiment of the invention, the display arrangement is an emissive display, such as an electroluminescent display, for example an OLED display. In a further embodiment of the invention, the display arrangement is a reflective display, such as an electrophoretic display or an electrowetting display.

The top of the light shielding arrangement interrupts the lens surface, so when reference is made to the shield extending “beneath the lens surface”, it is meant the surface that would be defined by the lenses with no light shield interrupting the surface. The lenses (or their cross section perpendicular to their long axis) have a single focal point which determines the lens shape. Thus, although the lens surface is disrupted by the light shielding arrangement, the (originally designed) lens surface can still be determined from the remainder of the lens.

The effect of the light shielding arrangement is to block (or reflect) shallow angle light that would otherwise result in waveguiding in the lens structure.

The light shielding arrangement can comprise a light blocking material to absorb light or an air gap to create increased total internal reflection of those shallow rays.

The light shielding arrangement can extend fully through the lens structure, and this can then completely prevent lateral light passage between lenses. This will also prevent multiple viewing cones.

Thus, it may be preferred for the light shielding arrangement to extend below the lens surface by a distance of between 0.1 and 0.3 times the maximum lens thickness. This means that shallow light that could cause waveguiding is blocked, but multiple viewing cones are still enabled.

The light shielding arrangement can extend below the lens surface by a distance h which satisfies:

$$h < 0.6 \cdot ( \frac{ep}{f} )$$

where e is the maximum lens thickness, p is the lens pitch and f is the focal length of the lenses.

This has been found to be a particularly suitable compromise between blocking of waveguiding light and allowing multiple viewing cones.

The lenticular lenses can extend in a pixel column direction or can be inclined at an acute angle to the pixel column direction, wherein each lens covers a plurality of pixel columns.

### BRIEF DESCRIPTION OF THE DRAWINGS

An embodiment of the invention will now be described, purely by way of example, with reference to the accompanying drawings, in which:

FIG. 1 is a schematic perspective view of a known autostereoscopic display device;

FIG. 2 shows how a lenticular array provides different views to different spatial locations;

FIG. 3 schematically shows the structure of a single pixel of an OLED display, and in the form of a backward emitting structure;

FIG. 4 shows how the light paths are affected when applying a lenticular lens to a top emitting structure;

FIG. 5 shows a first example of pixel structure in accordance with the invention;

FIG. 6 shows a simulation of the optical performance of the example of FIG. 5;

FIG. 7 shows a variation using an air gap;

FIG. 8 shows a variation with a deeper absorbing structure;

FIG. 9 shows a simulation of the optical performance of the example of FIG. 8;

FIG. 10 shows a ray simulation to enable the optimal wedge height to be determined;

FIG. 11 shows the same simulation as in the left part of FIG. 10 but for different lens designs; and

FIG. 12 shows a plot of optimal wedge height against the reciprocal of the F-number.

### DETAILED DESCRIPTION OF THE EMBODIMENTS

The invention provides a lenticular lens based autostereoscopic display arrangement. The interface between adjacent lenticular lenses is interrupted by a light shielding arrangement, which extends at least from the lens surface at the interface into the lens structure, thereby providing a shield extending beneath the lens surface. This reduces lateral progression of light in the lenticular lens arrangement and thereby reduces cross talk caused by waveguiding in the lens material.

Hereinbelow, embodiments of the present invention will be described on the basis of an electroluminescent display, which is an example of an emissive display. The skilled person will understand that the invention can be applied in lenticular lens based autostereoscopic display arrangements comprising any kind of emissive display, and also in lenticular lens based autostereoscopic display arrangements comprising any kind of reflective display, as in all these display types light will be directed (via emission or via reflection) from a pixel to the lenticular lenses over a wide range of directions.

The basic operation of a known 3D autostereoscopic display will first be described.

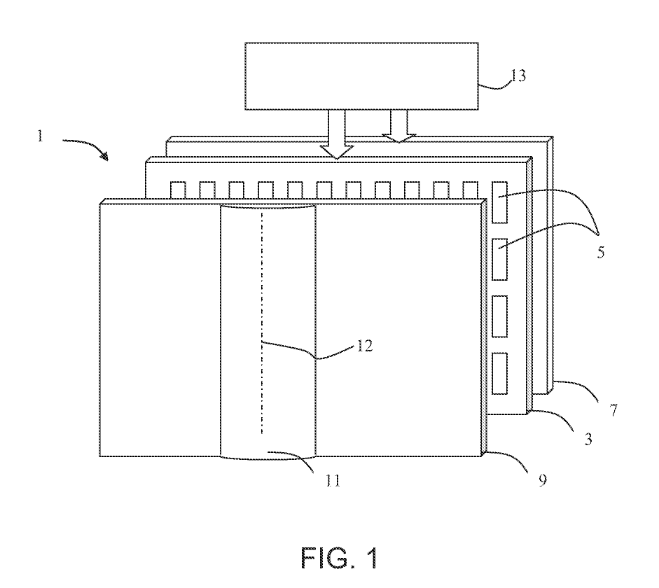

FIG. 1 is a schematic perspective view of a known direct view autostereoscopic display device 1 using an LCD panel to generate the images. The known device 1 comprises a liquid crystal display panel 3 of the active matrix type that acts as a spatial light modulator to produce the display.

The display panel 3 has an orthogonal array of display pixels 5 arranged in rows and columns. For the sake of clarity, only a small number of display pixels 5 are shown in the Figure. In practice, the display panel 3 might comprise about one thousand rows and several thousand columns of display pixels 5.

The structure of the liquid crystal display panel 3 as commonly used in autostereoscopic displays is entirely conventional. In particular, the panel 3 comprises a pair of spaced transparent glass substrates, between which an aligned twisted nematic or other liquid crystal material is provided. The substrates carry patterns of transparent indium tin oxide (ITO) electrodes on their facing surfaces. Polarising layers are also provided on the outer surfaces of the substrates.

Each display pixel 5 comprises opposing electrodes on the substrates, with the intervening liquid crystal material therebetween. The shape and layout of the display pixels 5 are determined by the shape and layout of the electrodes. The display pixels 5 are regularly spaced from one another by gaps.

Each display pixel 5 is associated with a switching element, such as a thin film transistor (TFT) or thin film diode (TFD). The display pixels are operated to produce the display by providing addressing signals to the switching elements, and suitable addressing schemes will be known to those skilled in the art.

The display panel 3 is illuminated by a light source 7 comprising, in this case, a planar backlight extending over the area of the display pixel array. Light from the light source 7 is directed through the display panel 3, with the individual display pixels 5 being driven to modulate the light and produce the display.

The display device 1 also comprises a lenticular sheet 9, arranged over the display side of the display panel 3, which performs a view forming function. The lenticular sheet 9 comprises a row of lenticular elements 11 extending parallel to one another, of which only one is shown with exaggerated dimensions for the sake of clarity.

The lenticular elements 11 are in the form of convex cylindrical lenses, and they act as a light output directing means to provide different images, or views, from the display panel 3 to the eyes of a user positioned in front of the display device 1.

The device has a controller 13 which controls the backlight and the display panel.

The autostereoscopic display device 1 shown in FIG. 1 is capable of providing several different perspective views in different directions. In particular, each lenticular element 11 overlies a small group of display pixels 5 in each row. The lenticular element 11 projects each display pixel 5 of a group in a different direction, so as to form the several different views. As the user's head moves from left to right, his/her eyes will receive different ones of the several views, in turn.

In the case of an LCD panel, a light polarising means must also be used in conjunction with the above described array, since the liquid crystal material is birefringent, with the refractive index switching only applying to light of a particular polarisation. The light polarising means may be provided as part of the display panel or the imaging arrangement of the device.

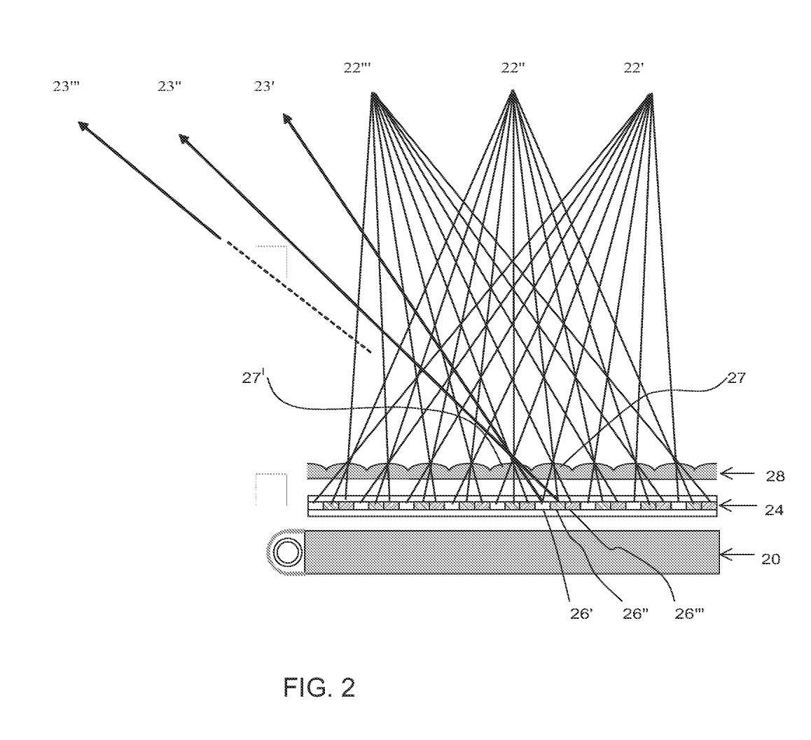

FIG. 2 shows the principle of operation of a lenticular type imaging arrangement as described above and shows the backlight 20, display device 24 such as an LCD and the lenticular array 28. FIG. 2 shows how the lenticular arrangement 28 directs different pixel outputs to three different spatial locations 22′, 22″, 22′″. These locations are all in a so-called viewing cone, in which all views are different. The views are repeated in other viewing cones, which are generated by pixel light passing through adjacent lenses. The spatial locations 23′, 23″, 23′″ are in the next viewing cone.

The use of an OLED display avoids the need for a separate backlight and polarizers. OLED promises to be the display technology of the future. However, a problem currently with OLED display is the light extraction out of the device. Without taking any measures the light extraction out of the OLED can be as low as 20%.

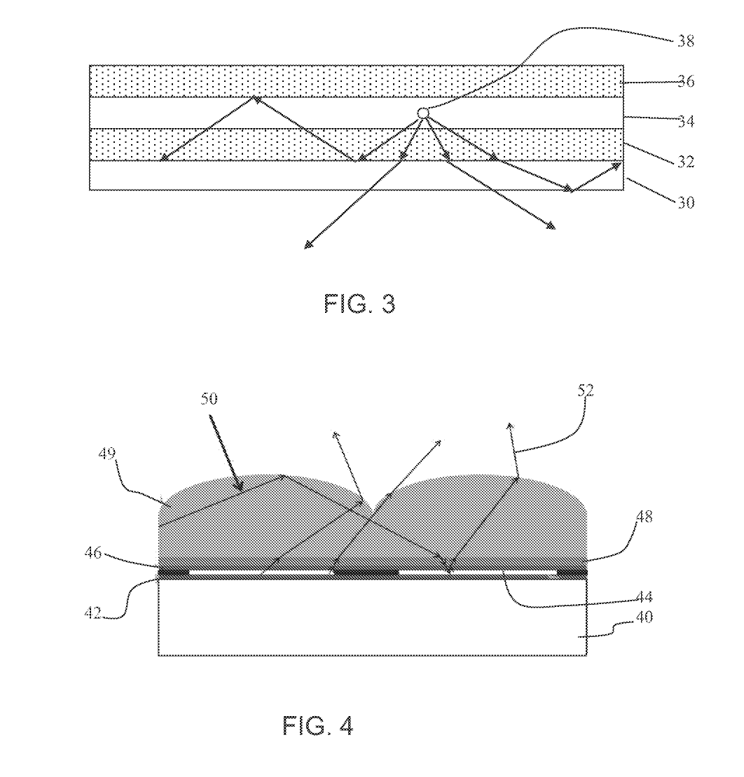

FIG. 3 schematically shows the structure of a single pixel of an OLED display, and in the form of a backward emitting structure (i.e. through the substrate).

The display comprises a glass substrate 30, a transparent anode 32, a light emissive layer 34 and a mirrored cathode 36.

The lines represent the path light can take when emitted from a point 38 in the organic layer. As the light is emitted from the source it can travel in all directions. When the light reaches the transition from one layer to another layer the difference between the refractive index of each of the layers determines whether the light can escape one layer and get into the next. The refractive index is determined by the speed of light in the material and is given by Snell's law:

$$\frac{sin {θ}_{1}}{sin {θ}_{2}} = \frac{{v}_{1}}{{v}_{2}} = \frac{{n}_{2}}{{n}_{1}}$$

wherein v is the velocity (in m/s), and n is the refractive index (unitless)

In the example of FIG. 3 the refractive index of the organic material forming the light emissive layer 34 is high (n=1.8) while the refractive index of glass is 1.45.

When the angle of incidence of light that travels from a material with a high refractive index to a material with a low refractive index is large enough, the light cannot leave the material. The angle of incidence the critical angle and is given by α=arcsin(n2/n1) for the organic material into glass. This gives 54 degrees.

Thus, it is clear that a lot of the light generated in the organic layer never leaves the layer but stays inside the material, where it is re-absorbed and drives another photon emission or turns into heat.

The same happens for the light that does leave the organic layer and enters the glass substrate. A lot of light cannot leave the glass at the glass to air interface.

Several solutions have been proposed both for ensuring the coupling of light out of the organic layers into the glass and for coupling the light out of the glass into the air.

The article by D. S. Mehta et. Al, “Light out-coupling strategies in organic light emitting devices” Proc. of ASID'06, 8-12 October, New Delhi gives an overview of the various solutions.

Whilst OLED devices are typically bottom emitting, and emit light through the glass substrate, another approach is to make the OLED stack top emitting such that the light emits through a transparent cathode and a thin encapsulating layer and not through the glass substrate. In general, different approaches to increasing the light extraction work better (or only) with either top or bottom emitting OLED structures.

The invention is described below based mainly on the use of a top-emitting OLED display. However the basic principle behind this invention can also be used with a bottom emitting OLED display, and all embodiments are applicable to both top and bottom emitting OLED structures.

Whilst the known solutions help to improve the light extraction efficiency up to 80% for lighting applications and for 2D displays, they do not provide a good solution for an autostereoscopic displays. A problem occurs when fitting a lenticular lens on the OLED display for creating an autostereoscopic TV. Even with a top emitting OLED, light will still be injected into a relatively thick glass layer causing the problems highlighted above, and a substantial amount of light will remain in waveguide mode in the glass. In principle, using a lenticular lens improves the light extraction from the glass into air as compared to a bottom emitting OLED but for a 3D display this has the side effect of reducing contrast and increasing crosstalk. This is a particular issue for 3D displays. For 2D displays, in many cases adjacent pixels will display the same colour (i.e. white or coloured areas of a screen, lines of single colour etc.) so that if any light escapes from a neighbouring pixel, this will simply add to the desired colour. However, in a 3D display, adjacent pixels do not in general have any relationship to each other, as they belong to different views and will generally be of different colour content. Thus, if any light escapes from a neighbouring pixel, this will seriously affect the quality of the image.

Furthermore, a substantial amount of light will still stay in waveguide mode in the glass. Part of this will be re-absorbed.

FIG. 4 shows how the light paths are affected when applying a lenticular lens to a top emitting structure. The top emitting structure comprises a glass substrate 40, mirrored anode 42, light emissive layer defining pixels 44 and a transparent cathode 46. A sealing and passivation layer 48 is between the cathode 46 and the glass lenticular array 49.

As illustrated in FIG. 4, light is generated in the organic layer and some light enters the glass of the lenticular arrangement 49. Some of the light will stay in waveguide mode in the glass by virtue of the internal reflections 50 and enter the optical path of a neighbouring view (or pixel/subpixel). Here it may be reflected back and leave through the lens (as shown for light ray 52) or it may be re-absorbed in the pixel.

If the light does leave the lens of the neighbouring view it will create crosstalk.

The invention provides a pixel structure which deliberately reduces the aperture ratio of the OLED emitter and adds light redirecting structures (in the form of funnels/cones) designed to redirect light emitted above the critical angle into directions more perpendicular to the surface of the display, whereby more light will be emitted.

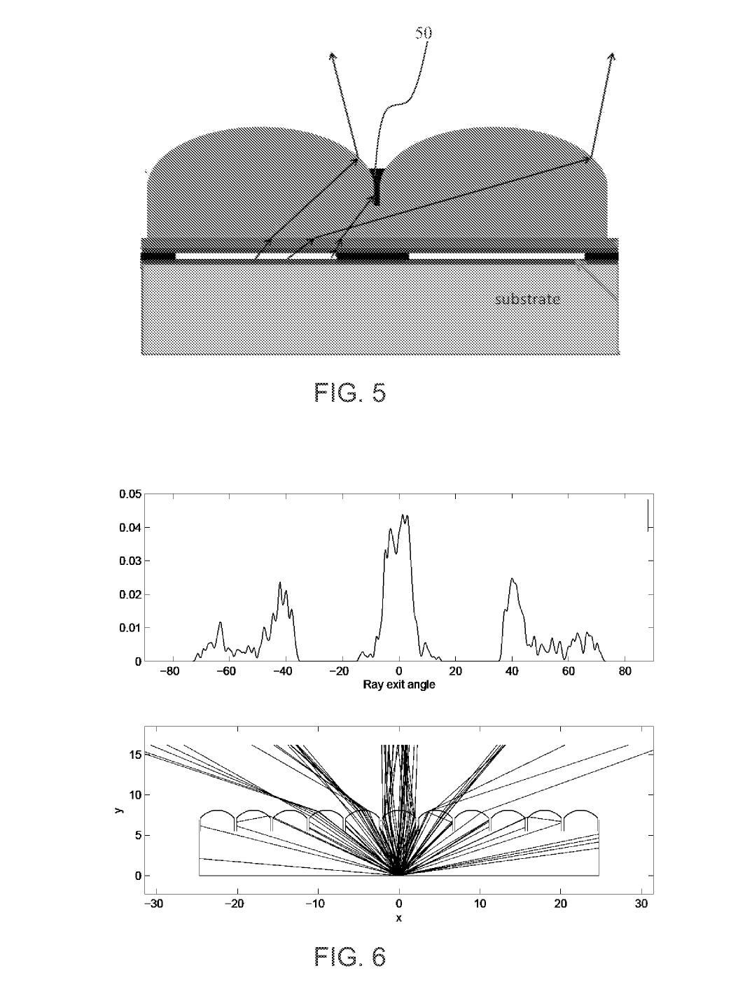

FIG. 5 shows a first example of pixel structure in accordance with the invention.

Compared to FIG. 4, a light shielding arrangement 50 is provided at the interface between adjacent lenticular lenses. This extends at least from the lens surface into the lens structure, namely below the normal lens surface.

This normal lens surface can be considered to be a “reference” lenticular lens surface. This reference lens is designed to focus from the optical viewing distance (or infinity) on to the emitters. The lenses can be cylindrical lenses, non-cylindrical such as parabolic, quadric or facetted to achieve this goal. Facetted lenses can be used to reduce banding. The quality (focus) of the lens may depend on viewing angle and also view number (which equates to the position of emitter in respect to nearest lens optical axis) and is based on the choices made in the lens design. All traditional lens designs are made to focus on the display plane but obviously cannot do so perfectly.

The “reference” lens can be defined by a lens function. Because the light shielding arrangement extends into the lens structure, the interface between the light shielding arrangement and the remaining lens material no longer has a shape which forms part of the that lens function. Thus, that part of the interface no longer focuses onto the display plane.

The light blocking arrangement thus alters the lens design, so that where the light block has been introduced, the interface with the remaining lens material beneath is no longer in accordance with the overall lens design for the remainder of the lens. Thus, because the light block is inserted into the lens structure it introduces a discontinuity in the optical characteristics of the remainder of the lens material.

If the general lens function of two adjacent lenses is modelled, this model will define surfaces which meet at point, and the light shielding arrangement extends beneath this point.

The invention thus introduces the light shielding element between each pair of adjacent lenticular lenses that causes most of the incident light that would otherwise cause crosstalk, to be absorbed.

As will be shown in the examples below, various materials can be used including an absorbent material, an air gap, or a transparent material that approximates the refractive index of air, such as an aerogel. Alternatively materials can be used that have a refractive index that is at least lower than that of the surrounding layers, such as graded films of SiO2 and TiO2, nanorods of SiO2, Teflon, etc.

In the example of FIG. 5, the lenticular sheet is altered to have an absorbing element 50 embedded between each pair of lenses. The principle is to have the absorbing element deep enough to block those rays that would otherwise waveguide before exiting the display at the wrong angle and position. By making the absorbing element not too deep, rays are still able to pass from one lens to another and thereby provide cone repetition as shown in FIG. 2. This ensures that the display is usable over a wider viewing angle than that of the central viewing cone alone.

FIG. 6 shows a simulation of the optical performance of the example of FIG. 5 and shows the paths of typical rays. The top plot shows the intensity variation with viewing angle, where 0 represents the direction normal to the display plane. The bottom plot shows visually the light paths.

The manufacture of the example of FIG. 5 is possible by designing a suitable shaped lenticular or by embossing a standard lenticular sheet. The absorber can be added by spraying on paint with carefully selected solvent to leave the lenses clear but fill the wells.

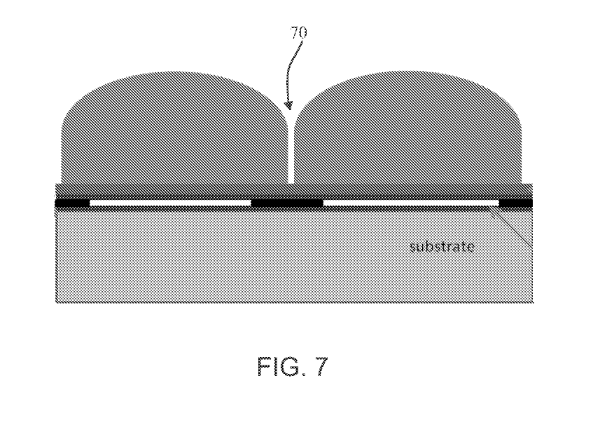

FIG. 7 shows a variation in which a vertical air gap 70 is provided between the lenses. This has a similar effect by ensuring that total internal reflection rays will not leave the glass-air interface or recombine in the OLED layer. Manufacturing is again possible by designing a specially-shaped lenticular or by embossing a standard lenticular lens array. No absorber would be needed.

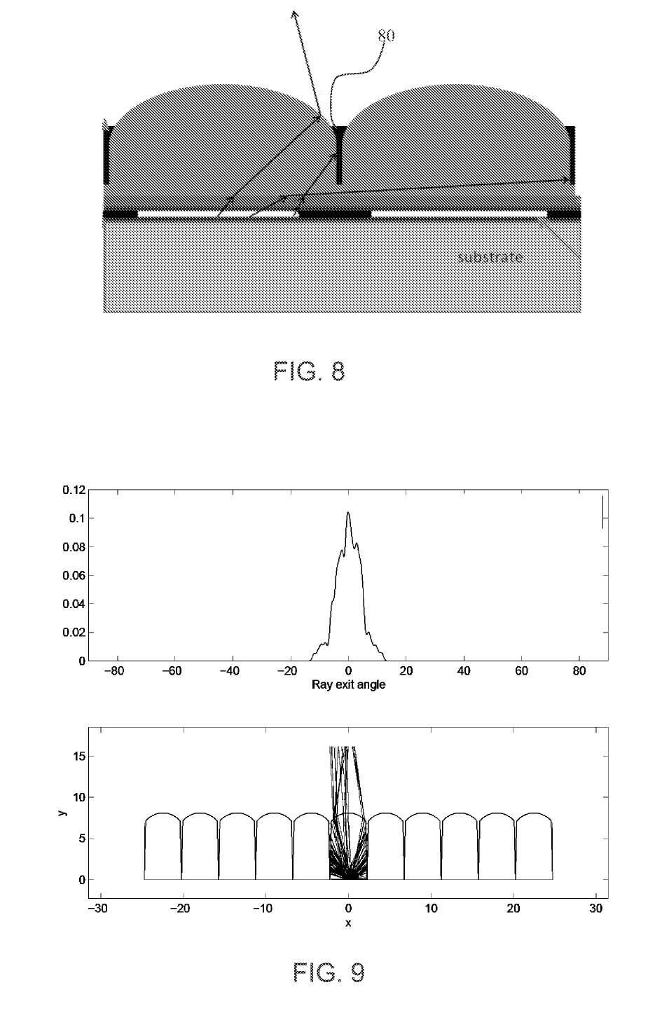

FIG. 8 shows a variation with a deeper absorbing structure 80 for a privacy display. Virtually all rays that would cross to another lenticule are blocked. This results in a single-cone display with a designable viewing angle of maximally 45° to 50°. Applications are single-user displays and privacy displays.

FIG. 9 shows a simulation of the optical performance of the example of FIG. 8 and shows the paths of typical rays. The top plot again shows the intensity variation with viewing angle, where 0 represents the direction normal to the display plane. The bottom plot shows visually the light paths.

Manufacturing is again possible by designing a specially-shaped lenticular array or by embossing a standard sheet. In this case, particular care is needed to maintain the structural integrity of the lenticular sheet. In practice, the lenticular sheet will not be entirely embossed and this is also not necessary, even for the privacy application, as can be seen from the simulation of FIG. 9.

In the example of FIG. 5, the absorbing wedge 50 is defined with a height that is just enough to block the total internal reflection rays. The wedge then reduces cross talk but still allows for cone repetitions. The design therefore needs a height which is able to achieve these two aims.

A cylindrical lenticular lens may be defined by three parameters:

the pitch (p);

the radius of curvature (r); and

the relative refractive index (n).

This determines the thickness (e) that the sheet requires such that the back of the lens is in focus, namely e=nr/(n−1)

For a wedge with height h<e, as measured from the top of the lens, it is desired to block all total internal reflection rays.

The focal length of the lenticular lens is determined by f=r/(n−1)

The strength of a lens is typically expressed as an F-number. A lens with F-number F/N has an aperture diameter equal to the focal length divided by N. For a lenticular lens N=f/p.

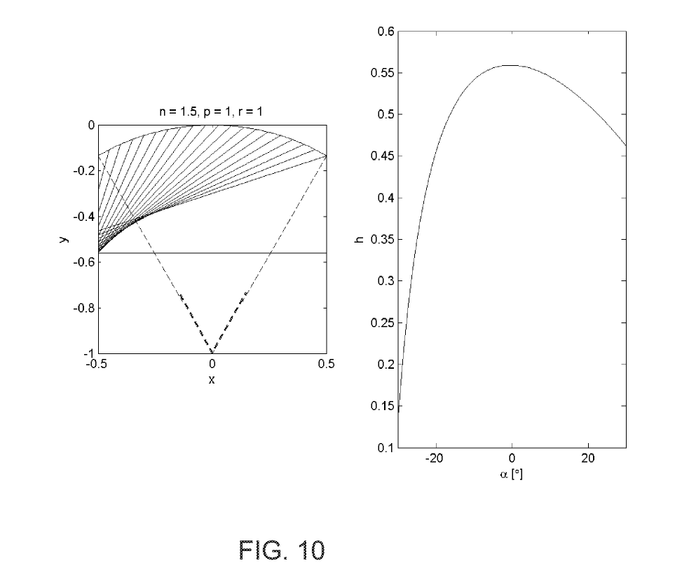

In order to determine the optimal wedge height, a ray simulation is used as shown in FIG. 10.

For each point along the lens surface, the left part of FIG. 10 plots the rays at the angle where total internal reflection arises, and the lowest ray into the depth of the lens is found. This provides an optimal wedge height shown as plot 100. Given that: h<e, the optimal wedge height is defined as:

$$h = {max}_{\vert α \vert \leq {α}_{ϕ}} r - r cos α + \frac{1}{2} ( p + 2 r sin α ) cot α + {θ}_{c} ,$$

where:

α is the angle with the optical axis,

$${α}_{p} = {sin}^{- 1} \frac{P}{2 r}$$

is the lens arc half angle, and

$${θ}_{0} = {sin}^{- 1} \frac{1}{n}$$

is the critical angle for total internal reflection.

The right part of FIG. 10 shows the required wedge depth as a function of viewing angle. As shown, the required wedge depth is less at the edges, and the light rays that require the deepest light blocking wedge are those that strike the lens surface near the centre.

FIG. 10 shows a lens design with n=1.5, p=1 and r=1.

The optimal wedge depth (i.e. depth from the top of the lens surface, and which may also be considered as the wedge “height”) is shown as h. This is rounded up to 1 decimal place. In the simulation of FIG. 10, the value is h=0.559 rounded up to h=0.6.

For the example of FIG. 10, e=nr/(n−1)=3, and this is the thickness of the lenticular sheet. FIG. 10 only shows the lenticular sheet from 0 down to thickness −1 below the top surface, but the lenticular sheet extends down to −3 in this example. The thickness of the optimum wedge height is 19% of the lenticular sheet thickness e (0.559/3=19%).

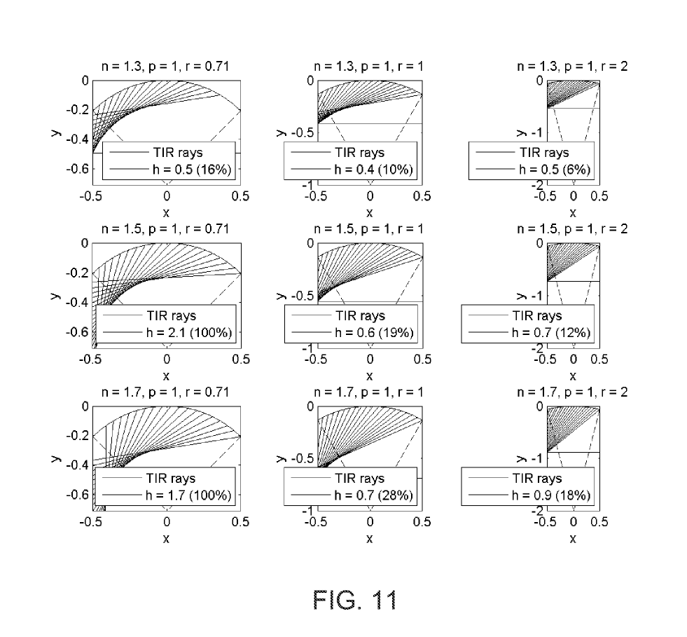

FIG. 11 shows the same simulation as in the left part of FIG. 10 but for different lens designs. The value p is always set to p=1. This simply means that all distances are specified in pitch units, since the lens designs can be linearly scaled.

As a consequence, the parameter space is only two-dimensional. The simulations in FIG. 11 show all combinations of r=√2, 1, 2 and n=1.3, 1.5, 1.7.

To provide an impression of the realism of these parameters, related F-numbers are shown in the table below.

The F-numbers are of simulation points in the parameter space.

| | r = √2 | r = 1 | r = 2 |
|---|---|---|---|
| n = 1.3 | F/2.4 | F/3.3 | F/6.7 |
| n = 1.5 | F/1.4 | F/2 | F/4 |
| n = 1.7 | F/1.0 | F/1.4 | F/2.9 |

The results are shown in FIG. 11, in which the optimal wedge height (again rounded up to 1 decimal place) is shown as part of the legend, both as a metric and a percentage of sheet thickness e, in the manner explained with reference to FIG. 10.

For two points

$$( r = \frac{1}{\sqrt{2}} , n \geq 1.5 ) ,$$

in the low F-number region, no solution was found, hence the values of h are greater than 1.

Typical lenses with practical F-numbers such as F/2 are suitable for use with the invention. Extremely low F-number lenses may cause total internal reflection inside individual lenticular lenses and thus should preferably not be used.

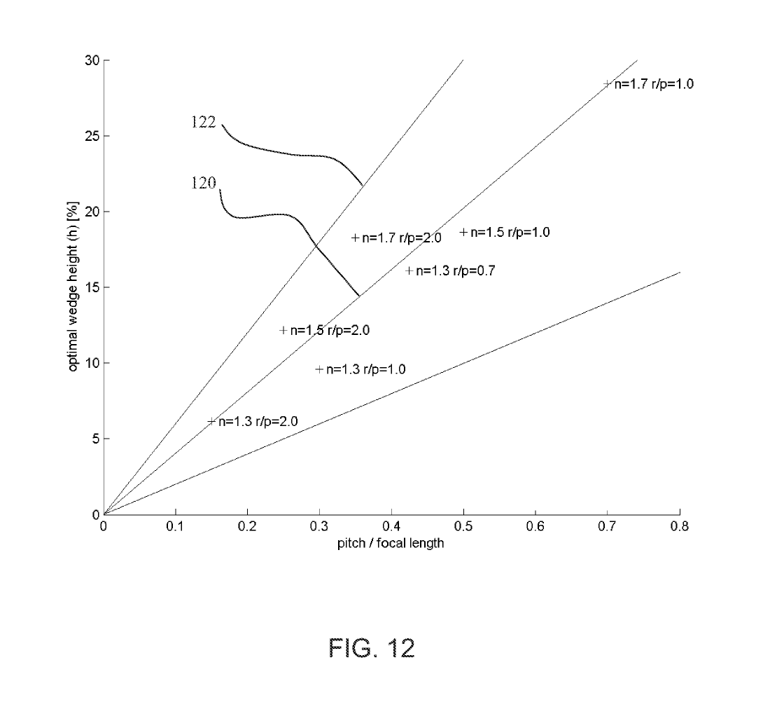

An interesting pattern arises if the optimal wedge height is plotted against the reciprocal of the F-number (which may be considered to be an aperture ratio), namely p/f, as shown in FIG. 12.

There is an approximately linear relationship between the aperture ratio and the wedge height (expressed as a fraction of the lens thickness e), meaning that for stronger lenses, thicker wedges are necessary. The line 120 in FIG. 12 is a fit to the data points, such that for a given wedge height (h), lenticular thickness (e), lenticular pitch (p) and focal length (f), an estimate of the wedge height (h) is given by:

$$\frac{h}{e} = 0.405 \frac{p}{f} = 0.405 \frac{p ( n - 1 )}{r} .$$

Thus line 120 has a slope of 0.405. A suitable wedge height can be found when h/e<0.6 p/f. The line with slope 0.6 is plotted as 122. Furthermore, the size of the wedge is preferably limited to 10-30% to allow for a good display viewing angle.

As is clear from the description above, the value e is the thickness of the lenticular sheet. In particular, this is the height from the top of the lens surface to the focal point of the lenses, regardless of whether the lens structure is a single layer or multiple layers between the focal plane and the top surface. Thus the “lens thickness” should be understood in this context.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. An autostereoscopic display device comprising:
a display arrangement comprising an array of spaced pixels;
an autostereoscopic lens arrangement having a lens surface, and comprising:
an array of parallel lenticular lenses over the display arrangement, wherein a plurality of pixels is provided beneath each lenticular lens,
a light shielding arrangement comprising a light blocking material provided at the interface between adjacent lenticular lenses, which extends at least from the lens surface at the interface between the adjacent lenticular lenses into the lens arrangement, thereby providing a shield extending beneath the lens surface, such that the lenticular lenses define the lens surface other than at the interfaces where the lens surface is disrupted by the light shielding arrangement,
wherein the light shielding arrangement extends below the lens surface by a distance of between 0.1 and 0.3 times the maximum lens thickness.

2. A device as claimed in claim 1, wherein the display arrangement is an emissive display arrangement.

3. A device as claimed in claim 2, wherein the emissive display arrangement is an electroluminescent display arrangement

4. A device as claimed in claim 1, wherein the display arrangement is a reflective display arrangement.

5. A device as claimed in claim 1, wherein the lenticular lenses extend in a pixel column direction or are inclined at an acute angle to the pixel column direction, wherein each lens covers a plurality of pixel columns.

6. (canceled)

7. (canceled)

8. (canceled)

9. (canceled)

10. A device as claimed in claim 1, wherein the light shielding arrangement extends below the lens surface by a distance h which satisfies h<0.6 (ep/f), where e is the maximum lens thickness, p is the lens pitch and f is the focal length of the lenses.
